(19) United States
(12) Patent Application Publication
(10) Pub. No.: US 2010/0236494 A1
(43) Pub. Date: Sep. 23, 2010

(54) Draft-proof animal passageway

(76) Inventor: George B. Maeder, Smithtown, NY (US)

Correspondence Address: DILWORTH & BARRESE, LLP, 1000 WOODBURY ROAD, SUITE 405, WOODBURY, NY, 11797, US

(21) Appl. No.: 12/381,801

(22) Filed: Mar. 17, 2009

(51) Int. Cl. A01K 1/035; E06B 7/00; E06B 7/28

(52) U.S. Cl. 119/484

(57) ABSTRACT

An animal passageway configured to facilitate egress and ingress to a building includes a bottom surface extending between a first end and a second end. The passageway is mounted with the building and the bottom surface is disposed a predetermined distance from a ground surface including a floor level within the building and/or a ground level adjacent the building. The first end defines a first opening including a first door and the second end defines a second opening including a second door. The bottom surface defines a third opening including a third door adjacent to the first end and a fourth opening including a fourth door adjacent to the second end. The third door and the second door are configured to facilitate egress, and the fourth door and the first door are configured to facilitate ingress, whereby movement of one of the doors to an open position is asynchronous with the remaining doors.

### TECHNICAL FIELD

The present disclosure generally relates to passageways for animals, and more particularly to a passageway having a plurality of doors, disposed in a predetermined configuration to facilitate passage of an animal through a structure in at least one pre-selected path, while preventing an undesired draft in the passageway.

### BACKGROUND

Animals such as pets and domesticated animals, which reside in a dwelling, often require frequent egress and ingress from the building for exercise and relief. This can require the presence of the animal's caretaker to facilitate such egress and ingress, which can be time consuming and inconvenient. Pet doors are generally known to facilitate such egress and ingress from the dwelling without the caretaker's presence. Such pet doors are typically mounted with a door and are of sufficient size to allow an animal to pass through. These pet doors can include a hinged door or a flexible flap to allow ingress and/or egress.

These types of pet doors, however, may fail to prevent outside air from entering the dwelling or inside air from escaping. Indeed, as an animal passes through these types of pet doors, outside air is permitted to enter the dwelling and inside air is permitted to escape, thus creating a draft. Such drafts can disadvantageously create an uncomfortable environment inside the dwelling, and result in higher energy costs, due to heat and/or cooling loss.

Therefore, it would be desirable to provide a passageway having a plurality of doors, disposed in a predetermined configuration to facilitate passage through a structure. The passageway can be configured to facilitate passage of an animal through the structure in at least one pre-selected path. Desirably, the passageway configuration prevents an undesired draft to and from the structure. Most desirably, the passageway includes a transparent portion configured to provide visual inspection of bodies and/or objects located both within and adjacent to the passageway. It is contemplated that the passageway includes a pet door assembly that is easily manufactured and assembled with an existing structure.

### SUMMARY OF THE INVENTION

Accordingly, a passageway is provided having a plurality of doors, disposed in a predetermined configuration to facilitate passage through a structure, to overcome the disadvantages and drawbacks of the prior art. The passageway may be configured to facilitate passage of an animal through the structure in at least one pre-selected path. Preferably, the passageway configuration prevents an undesired draft to and from the structure. Most preferably, the passageway includes a transparent portion configured to provide visual inspection of bodies and/or objects located both within and adjacent to the passageway. It is envisioned that the passageway includes a pet door assembly that is easily manufactured and assembled within an existing structure.

In one embodiment, an animal door assembly includes a top surface, a bottom surface, and two side surfaces configured to define a passageway having a first end, such as a proximal end, and a second end, such as a distal end. In a preferred embodiment, the animal door assembly defines a passageway having a rectangular cross-section large enough to allow a household pet, such as a ferret, bird, lizard, cat, or dog to pass through. However, it is understood that the cross-section of the passageway may be any shape including, for example, round, oval, square, triangular, hexagonal, octagonal, trapezoidal, or elliptical, without departing from the spirit of the invention.

In one embodiment, the passageway of the animal door assembly is about 26.0 inches long, about 9.5 inches high, and about 7.0 inches wide. In a preferred embodiment of the present invention, the passageway is large enough for an adult cat to walk though. However, it is envisioned that the passageway may be of any height, width, or length sufficient for a household pet to walk through, regardless of the size of the animal.

In another embodiment, the components of the passageway, including the top surface, the bottom surface, and the two side surfaces are formed of plastic or wood, such as pine or plywood.

In another preferred embodiment of the present invention, the components of the passageway, including the top surface, the bottom surface, and the two side surfaces are of a thickness of about ⅛ inch to about 1 inch. However, it is envisioned that the components of the passageway may be of any thickness suitable to form a passageway through which an animal can pass.

The passageway includes a first opening at the first end, a second opening at the second end, a third opening on the bottom surface of the first end, and a fourth opening on the bottom surface of the second end, to allow an animal to enter and exit. In another embodiment, the first opening, the second opening, the third opening, and the fourth opening are each about 9.25 inches in height, and about 5.0 inches in length. However, it is envisioned that each the openings are large enough to permit an animal to enter and exit therethrough, regardless of the size of the animal.

In another embodiment, the first opening, the second opening, the third opening, and the fourth opening are rectangular. However, it is understood that the first opening, the second opening, the third opening, and the fourth opening may be any shape including, for example, round, oval, square, triangular, hexagonal, octagonal, trapezoidal, or elliptical, without departing from the spirit of the invention.

The passageway includes a first door configured to cover the first opening, a second door configured to cover the second opening, a third door configured to cover the third opening, and a fourth door configured to cover the fourth opening. The doors are pivotally connected to the passageway to permit each door to pivot thereabout.

In another embodiment, the first door, the second door, the third door, and the fourth door are each rectangular. However, it is understood the first door, the second door, the third door, and the fourth door may be any shape including, for example, round, oval, square, triangular, hexagonal, octagonal, trapezoidal, or elliptical, without departing from the spirit of the invention.

The first opening is smaller than the first door, such that the first door completely covers the first opening when the first door is in its closed configuration. In particular, the first door completely covers the first opening to prevent air from passing therethrough.

Likewise, the second opening is smaller than the second door, such that the second door completely covers the second opening when the second door is in its closed configuration. In particular, the second door completely covers the second opening to prevent air from passing therethrough.

In another preferred embodiment of the present invention, the passageway is an animal door assembly including a first door and a second door which are each constructed of transparent material, such as plexiglass. As used herein, the term “transparent” refers to any material that permits light to pass therethrough so that bodies and/or objects can be seen, including, for example, transparent, translucent, and opaque materials. A transparent material is preferred for the first door and the second door. It is envisioned that the transparent door is constructed of a lightweight material to allow a pet animal to independently manipulate each door to pass therethrough.

In another embodiment, the first door and the second door are of a thickness of about ⅛ inch to 1 inch. However, it is envisioned that the first door and the second door may be of any thickness suitable to allow an animal to independently manipulate each door to pass therethrough.

The third opening, located on the bottom surface of the first end of the passageway, is smaller than the third door, which is configured to cover the third opening, such that the third door completely covers the third opening when the third door is in its closed configuration, to prevent air from passing therethrough. The fourth opening, on the bottom surface of the second end of the passageway, is smaller than the fourth door, which is configured to cover the fourth opening, such that the fourth door completely covers the fourth opening when the fourth door is in its closed configuration, to prevent air from passing therethrough. In one embodiment, the third door and the fourth door are of a thickness of about ⅛ inch to 1 inch. However, it is envisioned that the third door and the fourth door may be of any thickness suitable to allow an animal to independently manipulate each door to pass therethrough.

In another preferred embodiment of the present invention, the first opening, the second opening, the third opening, and the fourth opening have weather stripping disposed about at least one edge of each of the openings, to prevent air from flowing into the passageway from the outside, or ambient or conditioned air from flowing from inside the house into the passageway. In particular, it is envisioned that the weather stripping will further prevent air from flowing between each opening and each door.

Preferably, the animal door assembly of the present invention is configured to be mounted in the wall of a building or other structure, such as a house, shed or barn. In particular, it is envisioned that the animal door assembly is installed through an outside wall of a building, against a stud in the wall thereof, such that the bottom surface of the passageway is about 12.0 to about 15.0 inches above the floor on the inside of the building. The animal door assembly may be permanently affixed to the building.

Desirably, the animal door assembly is inserted longitudinally through an opening in the wall of a building such that the first end of the passageway is inside the building and the second end (the end opposite the first end) is outside the building, to define a passageway by which an animal travels from inside the house to the outside, and vice versa. While it is understood that either the first end or the second end may provide access to the inside of the house, that for the purposes of this description, it can be assumed that the first door, which is configured to cover the first opening in the first end of the passageway opens into the inside of the structure; and that the second door, which is configured to cover the second opening in the second end of the passageway opens to the outside of the structure.

In another embodiment, the animal door assembly of the present invention is configured to be mounted in a window, door, or other opening in a building in the same manner as the animal door assembly is inserted in the wall of a building, as described above. In this embodiment, the animal door assembly is removable.

In one embodiment of the present invention, the animal door assembly includes a first door, which is configured to cover the opening at the first end of the passageway, and a second door, which is configured to cover the opening at the second end which of the passageway, which are each pivotally connected to the exterior of the passageway by hinges. The hinges are configured to facilitate swinging of the doors outwardly, relative to the passageway, to allow an animal to exit, but not enter, the passageway. Accordingly, an animal exits the passageway through the first opening, at the first end of the passageway, by pushing through the first door using, for example, its nose, snout, or paws. It is envisioned that the outwardly swinging doors will allow an animal to easily push the first door to go through the first opening and into the passageway.

It should be understood that the first door and the second door may be connected to the passageway in other manners, without departing from the spirit of the invention. For example, the first door and the second door may be slidably connected to the passageway via a track, or spring-loaded for movement.

In one embodiment of the present invention, the pet door includes a tunnel-like passageway having side surfaces that are trapezoidal in shape to create a passageway which is sloped at either end, to encourage the doors at either end of the passageway (the first door and the second door) to remain closed, due to the force of gravity.

In another embodiment of the present invention, the animal door assembly includes a third door and a fourth door, which are each pivotally connected to the interior of the passageway by hinges, which are configured to facilitate swinging of the doors inwardly, relative to the passageway, to allow an animal to enter, but not exit, the passageway. Accordingly, an animal that wishes to enter the passageway gains access to the third opening by lifting the door using, for example, its nose, snout, or paws. It is envisioned that the inwardly swinging doors will allow an animal to easily lift the third and fourth doors to go through the opening.

The hinge(s) that pivotally connect the first door can be located along the top surface of the passageway on the first end thereof. Likewise, the hinge(s) that pivotally connect the second door can be located along the top surface of the passageway on the second end thereof.

It should be understood that the third door and the fourth door may be connected to the passageway in other manners, without departing from the spirit of the invention. For example, the third door and the fourth door may be slidably connected to the passageway in a track, or spring loaded for movement.

Accordingly, for traveling along a preselected path from the outside of the house (or other structure) to the inside of the house through the animal door assembly of the present invention, an animal enters the animal door assembly through the passageway via the fourth door, which is configured to cover the fourth opening, located on the bottom surface of the second end of the passageway. Once the animal is inside the passageway, the fourth door closes, thus preventing outside air from entering the passageway. The animal then moves along a pre-selected path from the second end of the passageway to the first end of the passageway, where the animal is permitted to exit the passageway through the first door, which is configured to cover the opening at the first end of the passageway, therefore providing the animal access to the inside of the house. In that, the fourth door is closed after the animal enters the passageway, drafts are prevented from entering the passageway, and thus the inside of the house, as the animal enters the house through the first door of the passageway.

To travel along a preselected path from inside a house (or other structure) to the outside through the animal door assembly of the present invention, an animal enters the passageway via the third door, which is configured to cover the third opening on the bottom surface of the first end of the passageway. Once the animal is inside the passageway, the third door closes, thereby preventing air from inside the house from escaping into the passageway. The animal then moves in a pre-selected path from the first end of the passageway to the second end of the passageway, where the animal is permitted to exit the passageway through the second door, which is configured to cover the opening at the second end of the passageway, therefore providing the animal access to the outside. In particular, hinges may be intermittently or continuously disposed along one edge of the corresponding opening.

It is contemplated that hinges for use with the present invention may include, but are not limited to: piano hinges, flush hinges, overlay hinges, inset hinges, architectural hinges, pivot hinges, butt hinges, mortise hinges, continuous hinges, concealed hinges, butterfly hinges, parliament hinges, strap hinges, H hinges, HL hinges, counterflap hinges, coach hinges, rising butt hinges, spring hinges, double action spring hinges, T-hinges, friction hinges, security hinges, cranked hinges, lift-off hinges, self-closing hinges, flush European hinges, surface mount hinges, barrel hinges, two leaf hinges, ball bearing hinges, square corner hinges, radius corner hinges, non-mortise hinges, half wrap around hinges, full wrap around hinges, Euro overlay face frame hinges, Euro overlay hinges, and radius square corner hinges.

In one embodiment, the doors include audible indicia of entry and/or exit from the passageway including at least one bell or other noisemaking device, which is configured to provide an audible alert, noise or alarm when an animal enters or exits the passageway through at least one of the doors. It is envisioned that the present invention may include various devices to provide audible indicia when an animal enters or exits the passageway through the first door or the second door, including, for example, rattles and electronic devices.

In one embodiment, in accordance with the principles of the present disclosure, an animal passageway configured to facilitate egress and ingress to a building is provided. The passageway includes a bottom surface extending between a first end and a second end. The passageway is mounted with the building and the bottom surface is disposed a predetermined distance from a ground surface, such as a floor level within the building and/or a ground level adjacent the building. The first end defines a first opening including a first door and the second end defines a second opening including a second door. The bottom surface defines a third opening including a third door adjacent to the first end and a fourth opening including a fourth door adjacent to the second end.

The third door and the second door are configured to facilitate egress, and the fourth door and the first door are configured to facilitate ingress, whereby movement of one of the doors to an open position is asynchronous with the remaining doors.

The animal passageway can include a housing that defines the passageway. The housing is mounted with the building. The first door may be pivotally movable relative to a top surface of the passageway between an open and a closed position. The fourth door may be pivotally movable relative to the bottom surface between an open and a closed position. The second door can be pivotally movable relative to a top surface between an open and a closed position. The third door can be pivotally movable relative to the bottom surface between an open and a closed position.

Alternatively, the first door and the fourth door are pivotable in the same direction to facilitate egress. The second door and the third door can be pivotable in a direction opposite the direction of the movement of the first and fourth doors to facilitate egress. The passageway can define a longitudinal axis and the first and second ends are aligned with the longitudinal axis.

In an alternate embodiment, the housing has a trapezoidal cross-section. The first opening may define a plane disposed at an acute angle relative to a plane defined by the bottom surface. The second opening may define a plane disposed at an acute angle relative the bottom surface plane.

In another embodiment, at least one of the doors is transparent. Each of the openings can define an inner surface that include insulation. At least one of the doors may include audible indicia to identify movement thereof.

In another embodiment, an animal door assembly is provided, which includes a passageway defining a top surface and a bottom surface, and extending between a first and a second end. The passageway is mounted with a building and the bottom surface is disposed a predetermined distance from a ground surface, such as a floor level within the building and/or a ground level adjacent the building. The first end is disposed internal to the building and defines a first opening having a first door pivotally movable relative thereto. The second end is disposed external to the building and defines a second opening having a second door pivotally movable relative thereto. The bottom surface defines a third opening including a third door adjacent the first end and a fourth opening including a fourth door adjacent the second end.

The first and fourth doors defines a first predetermined path configured to facilitate egress from the building. The second and third doors define a second predetermined path configured to facilitate ingress to the building, whereby movement of one of the doors to an open position is asynchronous with the remaining doors.

In another embodiment, a pet door assembly is provided, which includes a housing having a top and a bottom surface and defining a passageway. The housing is mounted with a building and the bottom surface is disposed a predetermined distance from a ground surface adjacent the building. The passageway includes an external opening having an external door and an internal opening having an internal door. The bottom surface defines an outer opening having an outer base door and an inner opening having an inner base door. The inner base door and the external door are pivotable to define a first predetermined path and configured to facilitate egress of an animal from the building.

The outer base door and the internal door are pivotable to define a second predetermined path and configured to facilitate ingress of an animal to the building, whereby movement of one of the doors to an open position is asynchronous with the remaining doors. The external opening defines a plane disposed at an acute angle relative to a plane defined by the bottom surface and the internal opening defines a plane disposed at an acute angle relative to the bottom surface plane.

### BRIEF DESCRIPTION OF THE DRAWINGS

The present disclosure will become more readily apparent from the specific description accompanied by the following drawings, in which:

FIG. 1 is side, cross-section view of one particular embodiment of a pet door assembly in accordance with the principles of the present disclosure assembled with a structure, shown in cut-away;

FIG. 2 is a perspective view of the pet door assembly shown in FIG. 1;

FIG. 3 is an end view of the pet door assembly shown in FIG. 2;

FIG. 4 is a side view of the pet door assembly shown in FIG. 2;

FIG. 5 is a top view of the pet door assembly shown in FIG. 2; and

FIG. 6 is a bottom view of a pet door assembly shown in FIG. 2.

Like reference numerals indicate similar parts throughout the figures.

### DETAILED DESCRIPTION OF THE INVENTION

The exemplary embodiments of the present disclosure are discussed in terms of passageways for animals, and more particularly to a passageway having a plurality of doors disposed in a predetermined configuration to facilitate passage of an animal through a structure, while preventing an undesired draft in the passageway. It is envisioned that the passageway includes a pet door assembly configured to facilitate passage of the animal through the structure in at least one pre-selected path. It is further envisioned that the pet door assembly configuration prevents an undesired draft to and from the structure. It is contemplated that the passageway of the present disclosure may be assembled with various structures, both residential and commercial, such as, for example, homes, shelters, sheds and barns. It is further contemplated that the passageway may be employed for various animals, such as, domesticated animals, pets and farm animals.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

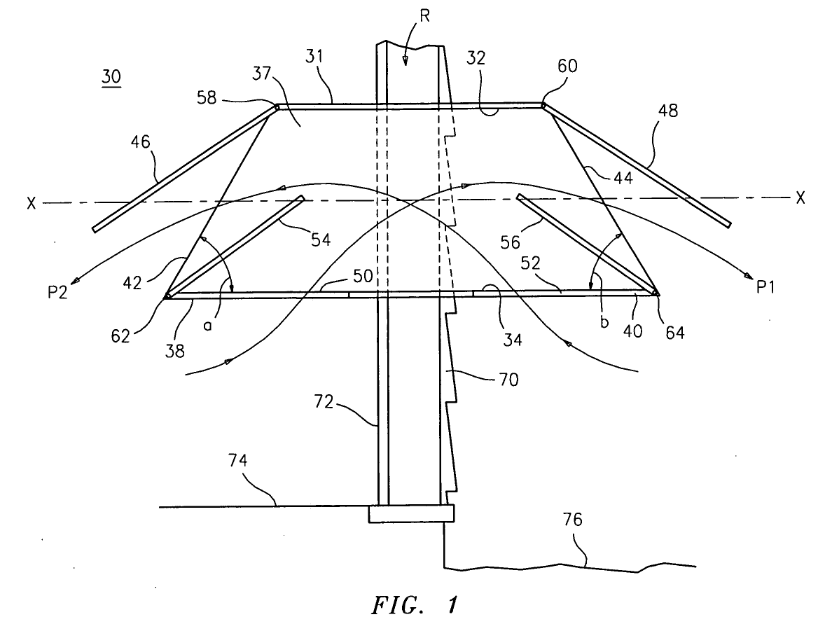

The following discussion includes a description of a passageway, related components and exemplary methods of employing the passageway in accordance with the principles of the present disclosure. Alternate embodiments are also disclosed. Reference will now be made in detail to the exemplary embodiments of the present disclosure, which are illustrated in the accompanying figures. Turning now to FIGS. 1-6, there is illustrated components of a pet door assembly 30 in accordance with the principles of the present disclosure.

Pet door assembly 30 is configured to facilitate egress and ingress to a building. Pet door assembly 30 includes a housing 31 that defines a passageway 37. Housing 31 has a bottom surface 34 of passageway 37 extending between a first end 38 and a second end 40. It is contemplated that passageway 37 may extend along all or only a portion of housing 31. Passageway 37 defines a longitudinal axis x, whereby first end 38 and second end 40 are aligned with longitudinal axis x.

Housing 31 has a trapezoidal cross-section configuration. Housing 31 includes trapezoidal side surfaces 36 such that passageway 37 is sloped at either end. As such, top surface 32 is shorter in length than bottom surface 34. This configuration advantageously urges internal door 46 and external door 48 to the closed position, due to the force of gravity, when not engaged by an animal or other manipulation, further facilitating the asynchronous operation of pet door assembly 30 described herein. It is envisioned that housing 31 may have various cross-section configurations, such as rectangular, square, elliptical polygonal and irregular.

Passageway 37 is mounted with a building, such as, for example, a residential home R. Passageway 37 is defined longitudinally through a frame opening 68 of home R such that first end 38 is disposed inside home R, relative to interior wall 72. Second end 40 is disposed outside home R relative to siding 70, thereby defining a preselected path of passageway 37 for an animal to travel from the inside of home R to outside home R, and vice versa. It is contemplated that pet door assembly 30 may be configured for mounting in a window, door, or other opening in a building, and/or may be removable.

Bottom surface 34 is disposed a predetermined distance from ground surfaces, such as, for example, floor 74 (15-16 inches) and ground 76 (more than 16 inches and would need the ramp) adjacent home R. It is envisioned that passageway 37 has a rectangular cross-section, along and traverse to longitudinal axis x, which is large enough to allow a pet, such as a ferret, bird, lizard, cat, or dog to pass through. It is further envisioned that the cross-section of passageway 37 may be variously configured including, for example, round, oval, square, triangular, hexagonal, octagonal, trapezoidal, or elliptical.

First end 38 defines a first opening, such as, for example, internal opening 42 and includes a first door, such as, for example, internal door 46. First opening 42 defines a plane disposed at an acute angle a relative to a plane defined by bottom surface 34. Second end 40 defines a second opening, such as, for example, external opening 44 and includes a second door, such as, for example, external door 48. Second opening 44 defines a plane disposed at an acute angle b relative to a plane defined by bottom surface 34. It is contemplated that angles a, b may be in a range of 20-75, and preferably 30-45 degrees.

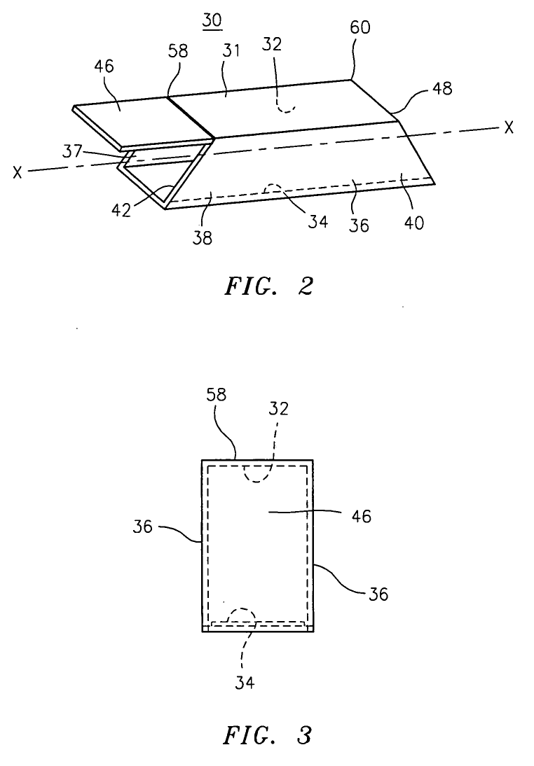

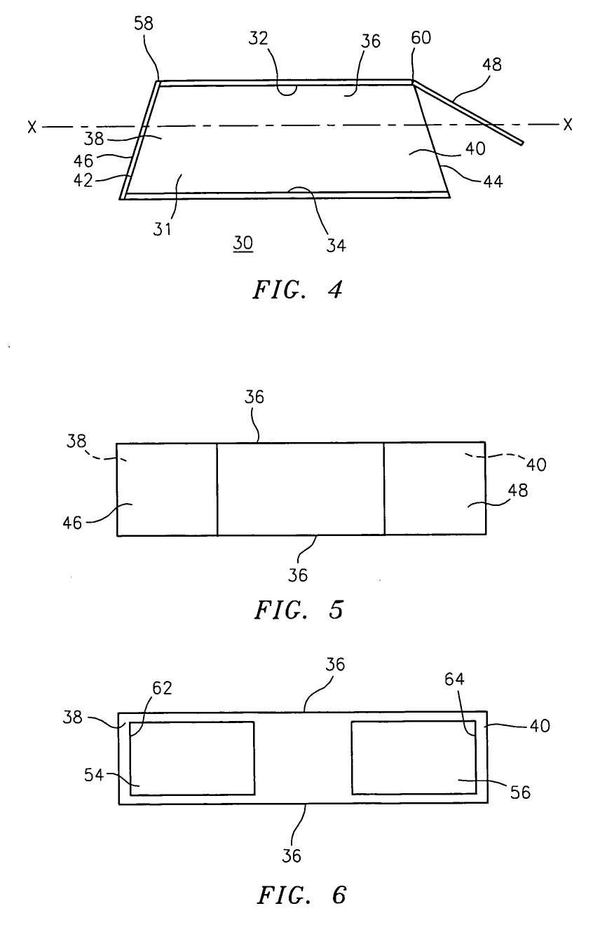

Internal door 46 is pivotally movable relative to a top surface 32 of passageway 37 between an open position (FIG. 1) and a closed position (FIG. 4). External door 48 is pivotally movable relative to top surface 34 between an open position (FIG. 1) and a closed position (FIG. 2). Internal door 46 and external door 48 are each pivotally connected to housing 31 by hinges 58 and 60, respectively, as shown in FIGS. 1 and 2, to facilitate egress from passageway 37. Hinge 58 is located at internal opening 42 along top surface 32. When internal door 46 is in the open position, internal door 46 opens away from bottom surface 34. Likewise, hinge 60 is located at external opening 44 along top surface 32. When external door 48 is in the open position, external door 48 opens away from bottom surface 34.

Hinges 58 and 60 are each configured to facilitate swinging of doors 46, 48 outwardly, relative to passageway 37, to allow animals to exit from passageway 37. Accordingly, an animal can exit passageway 37 through internal opening 42 or external opening 44 by traveling through the corresponding door using, for example, its nose, snout, or paws. It is envisioned that hinges 58 and 60 allow an animal to easily travel through the door under its power via pushing to go through internal opening 42 or external opening 44.

Bottom surface 34 defines a third opening, such as, for example, an inner opening 50 that includes a third door, such as, for example, an inner base door 54 at first end 38. Bottom surface 34 also defines a fourth opening, such as, for example, an outer opening 52, which includes a fourth door, such as, for example, outer base door 56 at second end 40. Outer base door 56 is pivotally movable relative to bottom surface 34 between an open position (FIG. 1) and a closed position (FIG. 4). Inner base door 54 is pivotally movable relative to bottom surface 34 between an open position (FIG. 1) and a closed position (FIG. 4). Inner base door 54 and outer base door 56 are each pivotally connected to housing 31 by hinges 62 and 64, respectively. Hinge 62 is located along an edge of inner opening 50 adjacent opening 42 along bottom surface 34. When inner base door 54 is in the open position, inner base door 54 opens away from bottom surface 34, toward first end 38. Likewise, hinge 64 is located along the edge of outer opening 52 adjacent opening 44 along bottom surface 34. When outer base door 56 is in the open position, outer base door 56 opens away from bottom surface 34, toward second end 40.

Hinges 62 and 64 are each configured to facilitate swinging of doors 46, 48 upwardly, relative to passageway 37, to allow animals ingress to passageway 37. Accordingly, an animal can enter passageway 37 through inner opening 50 or outer opening 52 by traveling through the corresponding door using its nose, snout, or paws. It is envisioned that hinges 62 and 64 allow an animal to easily travel through inner opening 50 or external opening 52, similar to that discussed.

Inner base door 54 and external door 48 define a first pre-selected path p1, as will be described, and are configured to facilitate egress of an animal from home R. Outer base door 56 and internal door 46 define a second pre-selected path p2, as will be described, and are configured to facilitate ingress of an animal to home R. As such, pet door assembly 30 advantageously prevents drafts to and from home R whereby movement of one of doors 46, 48, 54, 56 to an open position is asynchronous with the remaining doors.

In use, an animal travels through pet door assembly 30 and exits the inside of home R to travel to the outside of home R. An animal enters pet door assembly 30 through inner opening 50 by manipulating or pushing inner base door 54 up and then traveling through inner opening 50. It is envisioned that a box or ramp can be provided to allow an animal to reach inner opening 50 from floor 74.

The animal pushes inner base door 54 such that inner base door 54 pivots counterclockwise and sufficiently rotates relative to housing 31 into an open position for the animal to pass into passageway 37. When door 54 is in the open position, remaining doors 46, 48, 56 are disposed in a closed position, according to the asynchronous configuration of pet door assembly 30. Once the animal is inside passageway 37, inner base door 54 pivots clockwise and rotates relative to housing 31 to a closed position due to gravity. Air from inside home R is prevented from entering passageway 37, avoiding heat and/or cooling loss where inner base door 54 is open and moving to the closed position because doors 46, 48, 56 are closed in the asynchronous configuration described.

The animal is directed and moves along the first pre-selected path p1 from first end 38 to second end 40, such that the animal approaches second opening 44. With doors 46, 54, 56 in a closed position, the animal manipulates or pushes external door 48 outward and passes through external opening 44. It is envisioned that a box or ramp can be provided to allow an animal to more readily reach ground 76 from external opening 44. The animal pushes external door 48 such that external door 48 pivots counterclockwise and sufficiently rotates relative to housing 31 into an open position sufficiently for the animal to pass out of passageway 37. When door 48 is in the open position, remaining doors 46, 54, 56 are disposed in a closed position, according to the asynchronous configuration. Once the animal exits from passageway 37 and housing 31, external door 48 pivots clockwise and rotates relative to housing 31 to a closed position, due to gravity, thus preventing air from outside housing 31 from entering passageway 37, avoiding undesired outside air from entering housing 31 and home R. The animal is directed and moves along the first pre-selected path P1, thereby providing the animal access to the outside.

For an animal to navigate and enter home R from outside home R through pet door assembly 30, an animal enters pet door assembly 30 through outer opening 52 by manipulating or pushing outer base door 56 upward and passing through outer opening 52. It is contemplated that a box or ramp can be provided to allow an animal to reach outer opening 52 from ground 76.

The animal pushes outer base door 56 such that outer base door 56 pivots clockwise and sufficiently rotates relative to housing 31, into an open position for the animal to pass into passageway 37. When door 56 is in the open position, remaining doors 46, 48, 54 are disposed in a closed position, according to the asynchronous configuration. Once the animal is inside passageway 37, outer base door 56 pivots counterclockwise and rotates relative to housing 31 to a closed position, due to gravity, thus preventing air from outside housing 31 and home R from entering passageway 37 avoiding undesired outside air from entering housing 31 and home R.

The animal is directed and moves along a second pre-selected path p2 from second end 40 to first end 38, such that the animal approaches internal opening 42. The animal manipulates or pushes internal door 46 outward and passes through internal opening 42. It is contemplated that a box or ramp can be provided to allow an animal to more readily reach floor 74 from internal opening 42. The animal pushes internal door 46 such that internal door 46 pivots clockwise and sufficiently rotates relative to housing 31 into an open position sufficiently for the animal to pass out of passageway 37. When door 46 is in the open position, remaining doors 48, 54, 56 are disposed in a closed position. Once the animal exits from passageway 37 and housing 31, internal door 46 pivots counterclockwise and rotates relative to housing 31 to a closed position, due to gravity, thus preventing air from inside home R from entering passageway 37, avoiding heat and/or cooling loss due to the asynchronous configuration described. The animal is directed and moves along second pre-selected path, p2 thereby providing the animal access to the inside of home R.

It is envisioned that doors 46, 48, 54, 56 may each be hingedly connected to housing 31 by one or a plurality of hinges. The hinges may be intermittently or continuously disposed along one edge of a corresponding opening. It is further envisioned that hinges 58, 60, 62, 64 may be spring loaded to facilitate movement of doors 46, 48, 54, 56. It is contemplated that hinges for use with the present invention may include, but are not limited to: piano hinges, flush hinges, overlay hinges, inset hinges, architectural hinges, pivot hinges, butt hinges, mortise hinges, continuous hinges, concealed hinges, butterfly hinges, parliament hinges, strap hinges, H hinges, HL hinges, counterflap hinges, coach hinges, rising butt hinges, spring hinges, double action spring hinges, T-hinges, friction hinges, security hinges, cranked hinges, lift-off hinges, self-closing hinges, flush European hinges, surface mount hinges, barrel hinges, two leaf hinges, ball bearing hinges, square corner hinges, radius corner hinges, non-mortise hinges, half wrap around hinges, full wrap around hinges, Euro overlay face frame hinges, Euro overlay hinges, and radius square corner hinges. Desirably, piano hinges are used to connect doors 46, 48, 54, 56 to housing 31.

In an alternate embodiment, at least one of doors 46, 48, 54, 56 include audible indicia of entry and/or exit from passageway 37, which may include a bell or other noisemaking device configured to provide an audible alert when an animal enters/exits passageway 37. In this regard, the audible indicia identifies movement of internal doors 46, 48, 54, 56. It is envisioned that a plurality or all of doors 46, 48, 54, 56 may include audible indicia.

In another embodiment, internal opening 42, external opening 44, inner opening 50, and outer opening 52 each include insulation along at least one edge or all the surfaces of openings 42, 44, 50, 52. The insulation may include weather stripping. The weather stripping may be disposed about openings 42, 44, 50, 52 to further prevent air from flowing into the passageway 37 or escaping therefrom to prevent heat/cooling loss from inside home R.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An animal passageway configured to facilitate egress and ingress to a building, the passageway including a bottom surface extending between a first end and a second end, the passageway being mounted with the building and the bottom surface being disposed a predetermined distance from a ground surface including a floor level within the building and/or a ground level adjacent the building, the first end defining a first opening including a first door and the second end defining a second opening including a second door, the bottom surface defining a third opening including a third door adjacent to the first end and a fourth opening including a fourth door adjacent to the second end, wherein
the third door and the second door are configured to facilitate egress, and the fourth door and the first door are configured to facilitate ingress, whereby movement of one of the doors to an open position is asynchronous with the remaining doors.

2. The animal passageway of claim 1, further comprising a housing that defines the passageway, the housing being mounted with the building.

3. The animal passageway of claim 1, wherein the first door is pivotally movable relative to a top surface of the passageway between an open and a closed position.

4. The animal passageway of claim 3, wherein the fourth door is pivotally movable relative to the bottom surface between an open and a closed position.

5. The animal passageway of claim 1, wherein the second door is pivotally movable relative to a top surface between an open and a closed position.

6. The animal passageway of claim 1, wherein the third door is pivotally movable relative to the bottom surface between an open and a closed position.

7. The animal passageway of claim 4, wherein the first door and the fourth door are pivotable in the same direction to facilitate egress.

8. The animal passageway of claim 7, wherein the second door and the third door are pivotable in a direction opposite the direction of the movement of the first and fourth doors to facilitate egress.

9. The animal passageway of claim 1, wherein the passageway defines a longitudinal axis and the first and second ends are aligned with the longitudinal axis.

10. The animal passageway of claim 2, wherein the housing has a trapezoidal cross-section.

11. The animal passageway of claim 1, wherein the first opening defines a plane disposed at an acute angle relative to a plane defined by the bottom surface.

12. The animal passageway of claim 11, wherein the second opening defines a plane disposed at an acute angle relative the bottom surface plane.

13. The animal passageway of claim 1, wherein at least one of the doors is transparent.

14. The animal passageway of claim 1, wherein each of the openings define an inner surface that include insulation.

15. The animal passageway of claim 1, wherein at least one of the doors include audible indicia to identify movement thereof.

16. An animal door assembly comprising:
a passageway defining a top surface and a bottom surface, and extending between a first and a second end, the passageway being mounted with a building and the bottom surface being disposed a predetermined distance from a ground surface including a floor level within the building and/or a ground level adjacent the building,
the first end being disposed internal to the building and defining a first opening having a first door pivotally movable relative thereto, the second end being disposed external to the building and defining a second opening having a second door pivotally movable relative thereto, the bottom surface defining a third opening including a third door adjacent the first end and a fourth opening including a fourth door adjacent the second end,
the first and fourth doors defining a first predetermined path configured to facilitate egress from the building, the second and third doors defining a second predetermined path configured to facilitate ingress to the building, whereby movement of one of the doors to an open position is asynchronous with the remaining doors.

17. The animal door assembly of claim 16, wherein at least one of the doors is transparent.

18. The animal door assembly of claim 16, wherein the first opening defines a plane disposed at an acute angle relative to a plane defined by the bottom surface.

19. The animal door assembly of claim 18, wherein the second opening defines a plane disposed at an acute angle relative to the bottom surface plane.

20. A pet door assembly comprising:
a housing having a top and a bottom surface and defining a passageway, the housing being mounted with a building and the bottom surface being disposed a predetermined distance from a ground surface adjacent the building, the passageway including an external opening having an external door and an internal opening having an internal door, the bottom surface defining an outer opening having an outer base door and an inner opening having an inner base door,
the inner base door and the external door being pivotable to define a first predetermined path and configured to facilitate egress of an animal from the building, the outer base door and the internal door being pivotable to define a second predetermined path and configured to facilitate ingress of an animal to the building, whereby movement of one of the doors to an open position is asynchronous with the remaining doors,
the external opening defining a plane disposed at an acute angle relative to a plane defined by the bottom surface and the internal opening defining a plane disposed at an acute angle relative to the bottom surface plane.
